(19) United States
(12) Patent Application Publication
(10) Pub. No.: US 2015/0061328 A1
(43) Pub. Date: Mar. 5, 2015

(54) AIRCRAFT PASSENGER SEAT

(71) Applicant: ZIM Flugsitz GmbH, Markdorf (DE)

(72) Inventors: Peter KALSBERGER, Wien (AT); Zie-Na KIM, Muenchen (DE); Maksym PRYKHODKO, Friedrichshafen (DE)

(21) Appl. No.: 14/468,502

(22) Filed: Aug. 26, 2014

(30) Foreign Application Priority Data
Aug. 28, 2013 (DE) 10 2013 014 226.1

(51) Int. Cl. B64D 11/06

(52) U.S. Cl. CPC B64D 11/06; B64D 2011/0679
USPC 297/163

(57) ABSTRACT

An aircraft passenger seat having a seat base and a backrest which has a support structure and having a frame which is provided for securing to a floor of an aircraft cabin, and having a folding table which is arranged with a table connection structure so as to be able to be folded on the aircraft passenger seat. The table connection structure is arranged within a width of the backrest.

This application claims the benefit under 35 USC §119(a)-(d) of German Application No. 10 2013 014 226.1 filed Aug. 28, 2013, the entirety of which is incorporated herein by reference.

### FIELD OF THE INVENTION

The invention relates to an aircraft passenger seat.

### BACKGROUND OF THE INVENTION

Aircraft passenger seats for aircraft in a variety of forms already form prior art. A folding table is generally arranged so as to be able to be folded on an aircraft passenger seat by means of a table connection structure.

The table connection structure comprises two table arms which are arranged laterally at the outer side on a seat frame or a support structure of a backrest of the aircraft passenger seat. Often the folding table can also be transversely displaced on the table connection structure so that an air passenger can pull the folding table even closer to himself when it is folded out.

### SUMMARY OF THE INVENTION

An object of the invention is to configure an aircraft passenger seat with a folding table in a more ergonomic manner.

The invention is based on an aircraft passenger seat having a seat base and a backrest which has a support structure and having a frame which is provided for securing to a floor in an aircraft cabin, and having a folding table which is arranged with a table connection structure so as to be able to be folded on the aircraft passenger seat. For the folding table having a table connection structure, there is consequently a folded-in and a folded-out state on the aircraft passenger seat. In the folded-in state, the table connection structure and the folding table are in abutment with the remaining aircraft passenger seat whilst, in the folded-out state, the table connection structure protrudes at least partially and the folding table on the table connection structure protrudes from the remaining aircraft passenger seat.

The central notion of the invention is that the table connection structure is arranged within the width of the backrest.

It is thereby possible to allow the table to “disappear”, preferably completely, in the depth of the backrest, that is to say, when viewing the backrest from the side, within a projection of the lateral backrest edging. In this instance, a backrest frame of the support structure of the backrest and/or the frame forms the lateral edge region. By means of this lateral delimitation region, in particular at the left and right, when the backrest is viewed from the rear side, no portions of the table connection structure and preferably also no portions of the folding table then protrude.

Consequently, space is initially saved in the lateral region of an aircraft passenger seat.

In a particularly preferred embodiment of the invention, the table connection structure is arranged within the depth or the thickness of the backrest. Consequently, the folding table, which substantially comprises a table panel, and the table connection structure can be completely accommodated in the depth or the thickness of the backrest when the connection structure and the folding table are folded in. Consequently, the aircraft passenger seat having a table connection structure and the folding table can be constructed to be more compact, whereby, without reducing the movement freedom for an air passenger, the seat spacing is reduced or, if the seat spacing remains the same, an increase of the movement freedom of the so-called “living space” is brought about. As a result of seat specifications, provisions are made for the backrest thickness, with there being comfort regions A to D. The term “backrest thickness” is intended to refer to the depth of a backrest if the backrest were to be penetrated from the rear side or from the abutment face. With the procedure according to the invention, it is possible to integrate the table connection structure directly into the backrest structure in order to gain “living space” or to be able to reduce the seat spacing.

In a further advantageous embodiment of the invention, the table connection structure is arranged on a rotation axle which may extend on the support structure of the backrest, or which is supported on a structure which is located in the vicinity. In this manner, it is first possible to produce a stable arrangement of the table connection structure with a folding table. For example, the rotation axle rotates for a pivotable arrangement of the table connection structure or the table connection structure is rotatably mounted on the rotation axle. In addition, it is also conceivable for the folding table to be assembled at a rotation location on the table connection structure so that the folding table can be pivoted about at least one axis. Optionally, a multi-axis pivotability is also possible.

In a further advantageous embodiment of the invention, the table connection structure is arranged within carrier strut portions of the support structure for the backrest. In particular, the table connection structure is arranged within an intermediate space between carrier strut portions, for example, of a peripheral carrier strut when viewed in the width direction. It is consequently possible to recess the table connection structure and in particular also the folding table within the depth of the carrier strut portions in the folded-in state. In this manner, the thickness or the depth of the backrest is not increased by the table connection structure and in particular the folding table, but instead is reduced in comparison with known embodiments, whereby the comfort class may be improved.

It is further advantageous for the table connection structure to be arranged at the inner side of carrier strut portions of the support structure for the backrest. Consequently, carrier strut portions of the support structure can be used for the connection of the table connection structure. It is not necessary to optionally use another structural element, such as a continuous axle, which is pivotable or on which the table connection structure is pivotable.

It is further preferable for the table connection structure to comprise two table carrier arms. The table carrier arms are, when viewed in the width direction, preferably arranged within a free region of a strut structure of the support structure of the backrest or even pressed together in a central region between the strut structure.

In order to obtain a simple, cost-effective and stable connection of the table, it is further proposed that the two table arms which are laterally connected to the table be replaced by a single central table connection arm which is then articulated in particular centrally to a carrier structure, for example, the backrest structure.

An arrangement of the table connection structure in the region of the center of the aircraft passenger seat is particularly advantageous when a single carrier arm or carrier arms which are closely moved together are used. The carrier arm or plurality of carrier arms can then be arranged in such a manner that they are positioned between the legs of an air passenger in the folded-out state of the folding table so that the movement freedom at the side of the legs is not impaired by the table connection structure. The table which is connected centrally and in the middle consequently increases the “living space”, reducing the seat spacing, in particular in the region of the knee of the passenger.

In a further preferred embodiment, the table connection structure is articulated in the region of the center of the backrest. In this manner, structural elements of the backrest can be used for the connection of the table connection structure, in particular the foldable connection.

In a further advantageous embodiment of the invention, the folding table and the table connection structure is recessed in the depth of the backrest. Consequently, no portion of the table connection structure with a folding table when viewed from the side protrudes beyond a projection of the side faces of the backrest.

In a further advantageous embodiment of the invention, the table is received centrally on the table connection structure. Greater construction or design freedom in the lateral regions of the table is thereby obtained.

### BRIEF DESCRIPTION OF THE DRAWINGS

A plurality of embodiments of the invention are explained in greater detail below in the drawings with further details and advantages being set out.

FIG. 1 is a side view of an aircraft passenger seat with a folded-out folding table;

FIG. 2 is a rear view of the aircraft passenger seat from FIG. 1, with the folding table folded in;

FIG. 3 is an oblique perspective view of the seat from FIGS. 1 and 2 with the folding table according to the invention in the folded-in position;

FIG. 4 is a perspective cut-out of the aircraft passenger seat according to FIGS. 1 to 3 in the folded-out state; and

FIG. 5 is another cut-out of the aircraft passenger seat according to FIG. 4 in a spatial illustration with a schematically indicated leg of an air passenger.

### DETAILED DESCRIPTION OF THE INVENTION

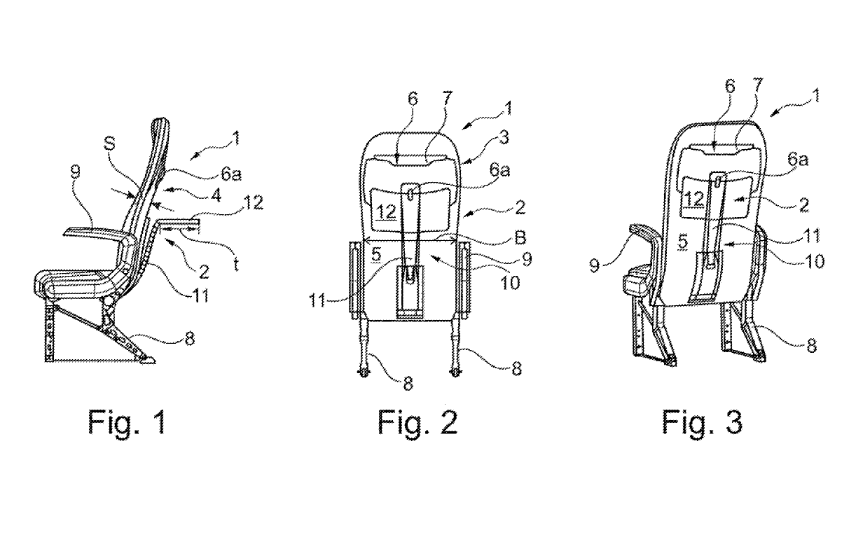

FIGS. 1 to 3 illustrate an aircraft passenger seat 1, a folding table arrangement 2 being illustrated in the folded-in position in FIGS. 2 and 3 and in the folded-out position in FIG. 1.

The aircraft passenger seat 1 comprises a backrest 3 having a rear side 4. The backrest 3 has a backrest structure in the form of a preferably peripheral strut (not illustrated).

In FIGS. 2 and 3, a cover 5 is adapted to the strut extent which is located therebelow so that the shape of the strut which extends therebelow cannot be identified.

When viewed in a width B of the backrest 3, for example, regions of the cover are located lower, that is to say, in a recessed state, with respect to a thickness S of the backrest 3. This available region of the backrest is, for example, used by a document pocket 6 and the folding table arrangement 2. In particular, the folding table arrangement 2 is preferably completely recessed in the thickness S of the backrest.

That is to say, in a lateral projection, the folding table arrangement 2 does not protrude. The only protruding item in FIG. 1 is a locking lever 6a.

As a result of this measure, the region can advantageously be used for the folding table arrangement 2 over the width between a peripheral strut structure of the backrest.

Furthermore, there is still space for the document pocket 6 above the folding table arrangement 2 with an access recess 7.

The aircraft passenger seat 1 further has a frame 8, on which the backrest 3 and armrest 9 are mounted.

The folding table arrangement 2 comprises a table connection structure 10, which has a central strut 11, preferably at the center of the width of the backrest 3. On the central strut 11, at one side, the table connection structure 10 is pivotably articulated to the backrest 3 and, at the other side, a folding table 12 is pivotably connected to the table connection structure 10.

FIGS. 2 and 3 show the folded-in state of the folding table arrangement 2. The folding table arrangement 2 is retained in this position by means of the locking lever 6a, which is rotatably positioned in the region of the document pocket 6.

The table connection structure 10 is arranged in a lower region 3a of the backrest 3 in such a manner that the central strut 11 is recessed in a recess 13 at the rear side 4 of the backrest in the folded-in state.

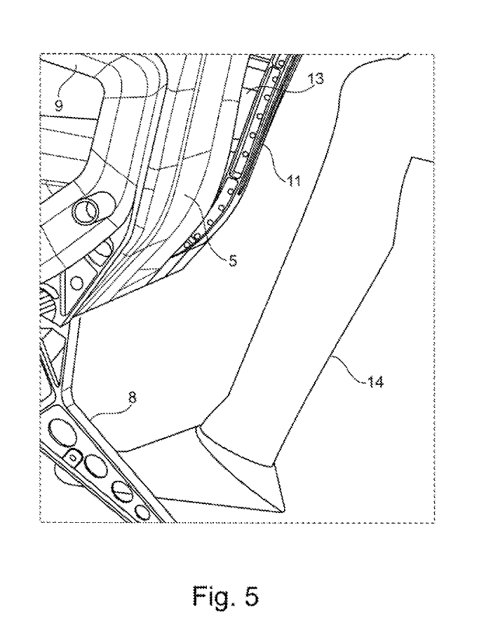

The recess 13 can be seen in particular in FIG. 5.

Depending on the embodiment of the folding table 12, that is to say, in particular the depth extent t thereof, a document pocket may, for example, be larger or smaller.

It is also conceivable for the folding table 12, for example, to be folded once so that, after the folding table 12 has been folded out, it can be folded up in order to achieve approximately a depth t as shown in FIGS. 1 to 3.

In a short variant, however, the folding table 12 can still be used in order to place, for example, drinks containers or a glass thereon.

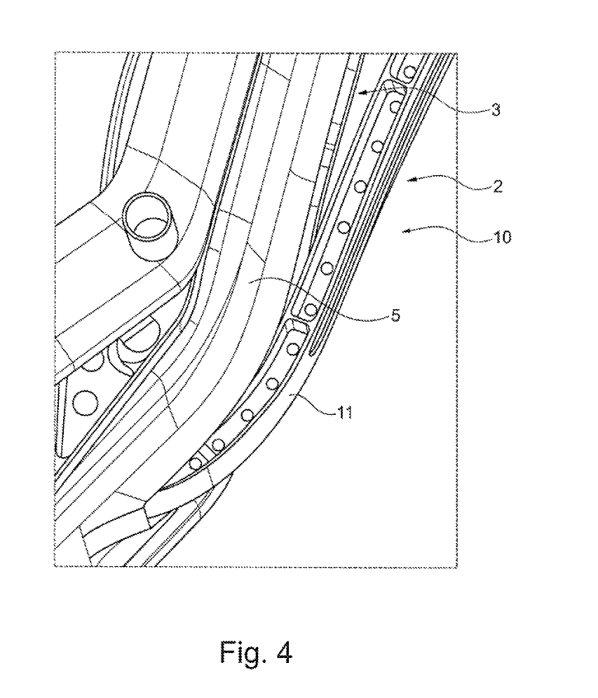

FIG. 4 is a perspective side view of a cut-out of the backrest 3 with a cover 5 and folded-out folding table arrangement 2, the central strut 11 being tilted away from the cover 5 of the backrest 3. The central strut 11 is positioned in a folded-away state between the legs of an air passenger so that the lateral movement freedom, in particular the knee itself, is not impaired in the folded-out state of the folding table arrangement.

The positioning of a leg 14 with respect to the central strut 11 in the folded-out position of the folding table arrangement 2 is schematically shown in FIG. 5.

In FIGS. 4 and 5, it can also be seen how the central strut 11 is pivoted out of the recess 13, but in the lower region still extends into the recess 13 and is pivotably retained at that location in particular by means of an axle. In the folded-in state, the central strut 11 is preferably completely recessed in the recess 13. The region of the rear side 4 of the backrest 3 can be “raised” from the rear side 4 at the position of the folded-in central strut and/or the lateral regions on the recess are inwardly recessed but preferably in such a manner that as before, in the folded-in state, the central strut is completely recessed. In particular when the lateral regions on the recess are inwardly recessed, there is more leg freedom for an air passenger. The raised region of the backrest, in which the central strut can be recessed, preferably forms with the central strut 11 a raised portion with “soft”, obliquely extending edges so that a person cannot collide with or even injure himself on them.

### LIST OF REFERENCE NUMERALS

1 Aircraft passenger seat
2 Folding table arrangement
3 Backrest
3a Lower region
4 Rear side
5 Cover
6 Document pocket
6a Locking lever
7 Access recess
8 Frame
9 Armrest
10 Table connection structure
11 Central strut
12 Folding table
13 Recess
14 Leg

1. An aircraft passenger seat comprising a seat base, a backrest that has a support structure, a frame that is provided for securing the seat to a floor of an aircraft cabin, and a folding table arranged with a table connection structure so as to be able to be folded on the aircraft passenger seat, wherein the table connection structure is arranged within a width of the backrest.

2. An aircraft passenger seat according to claim 1, wherein the table connection structure is arranged within a depth of the backrest.

3. An aircraft passenger seat according to claim 1, wherein the table connection structure is arranged on a rotation axle which extends on the support structure of the backrest.

4. An aircraft passenger seat according to claim 1, wherein the table connection structure is arranged within a width of carrier strut portions of the support structure for the backrest.

5. An aircraft passenger seat according to claim 1, wherein the table connection structure is arranged at an inner side of carrier strut portions of the support structure for the backrest.

6. An aircraft passenger seat according to claim 1, wherein the table connection structure comprises two table carrier arms.

7. An aircraft passenger seat according to claim 1, wherein the table connection structure has a single carrier arm.

8. An aircraft passenger seat according to claim 1, wherein the table connection structure is arranged in the region of the center of the aircraft passenger seat.

9. An aircraft passenger seat according to claim 1, wherein the table connection structure is articulated in the region of the center of the backrest.

10. An aircraft passenger seat according to claim 1, wherein the table can be recessed in the depth of the backrest.

11. An aircraft passenger seat according to claim 1, wherein the table is received centrally on the table connection structure.
